(19) United States
(12) Patent Application Publication
(10) Pub. No.: US 2025/0237437 A1
(43) Pub. Date: Jul. 24, 2025

(54) REFRACTORY BRICK PRODUCTION SYSTEM

(71) Applicant: Applied Motion Systems, Inc., Vancouver, WA (US)

(72) Inventors: Howard K. Brown, JR., Yacolt, WA (US); Andrew D. Drummond, Vancouver, WA (US); Nils M. Koskiniemi, Vancouver, WA (US); Carson E. Schlect, Vancouver, WA (US); Adam C. Williams, Vancouver, WA (US); Grant A. Owens, Vancouver, WA (US); Steven K. Kysar, Vancouver, WA (US)

(21) Appl. No.: 19/034,201

(22) Filed: Jan. 22, 2025

Related U.S. Application Data
(60) Provisional application No. 63/623,710, filed on Jan. 22, 2024.

(51) Int. Cl. F27D 1/04; F27D 1/16

(52) U.S. Cl. CPC F27D 1/04; F27D 1/1621

(57) ABSTRACT

A system for production of customizable refractory bricks in an automated fashion is described. The system receives refractory bricks, measures and performs quality control inspections and rejects out of specification bricks. The system planes the bricks to a consistent height and performs one or more machining operations to grind the bricks into a final shape before conveying the bricks for assembly in the order required for assembly rather than in a batch process.

### CROSS-REFERENCE TO RELATED APPLICATIONS

This application claims priority from U.S. Provisional Application No. 63/623,710, filed Jan. 22, 2024, the entire disclosure of which is incorporated herein by reference and for all purposes.

### TECHNICAL FIELD

This application is directed to systems and methods for processing refractory brick, and more specifically to fully automatic refractory brick shaping equipment and methods of using the same for the purpose of creating kilns and ovens of any variety of shapes and sizes.

### BACKGROUND

Walls and linings constructed from insulating firebrick are utilized in numerous applications in furnaces, kilns and high temperature applications as primary hot face refractory linings or as insulation behind other refractories. Such walls and linings are typically assembled on-site from smooth sided insulating firebrick and mortar and are laid down in courses. In some cases, kilns are assembled manually from machined bricks allowing close tolerance stacking obviating the need for mortar.

The process of shaping refractory bricks is a highly variable and manually intensive process that is inefficient and exposes operators to significant concentrations of silicates through airborne dust created in the brick shaping process.

The various examples of the present disclosure are directed toward overcoming one or more of the deficiencies noted above.

### SUMMARY

In an example of the present disclosure, the systems and techniques described herein relate to a production system for refractory bricks, the production system including: an infeed component that receives and orients the refractory bricks in a consistent manner; a quality control component that receives the refractory bricks from the infeed component and measures and visually inspects the refractory bricks, wherein refractory bricks failing the quality control component are rejected; a planing component that receives accepted refractory bricks from the quality control component and planes the refractory bricks to a uniform height; a machining component that receives planed refractory bricks and performs one or more operations according to a brick recipe defining a shape for the refractory bricks; a bevel component that adds a bevel to edges of the refractory bricks; a transfer system including one or more conveyors, robotic arms, turrets, and other such conveyor systems to transport refractory bricks between components in an automated fashion; and a control system that receives a brick recipe describing a final shape for a brick and controls operation of the components to produce the final shape.

In some aspects, the infeed component is configured to receive one or more input streams of refractory bricks and to orient the refractory bricks on an edge on a conveyor system that extends from the infeed component to the planing component. In some aspects, the machining component further includes a rotary turret that receives the refractory bricks from the planing component and positions the refractory bricks between one or more stations for performing the one or more operations. In some aspects, the control system is further configured to: receive an assembly order for the refractory bricks; determine a reverse assembly order describing an arrangement of refractory bricks in a storage configuration; and transfer, using the transfer system, the refractory bricks to a storage location in the reverse assembly order. In some aspects, the planing component, machining component, and bevel component each include cutters configured to grind or remove material from the refractory bricks as a powder. In some aspects, the system further includes a dust handling system including a capture assembly configured to draw the powder from grinding operations and capture the powder for disposal. In some aspects, the system further includes a robotic machining component including: one or more rotating cutting heads; and a robotic arm configured to retrieve refractory bricks from the transfer system and move the refractory bricks past the one or more rotating cutting heads to perform additional machining operations.

In some aspects, the techniques described herein relate to a method including: receiving, at an infeed conveyor system, a plurality of refractory bricks; receiving, at a controller, a kiln recipe describing dimensions and configurations of refractory bricks for assembling into a kiln; determining, using sensor data from a sensor system, that dimensions of the plurality of refractory bricks exceed minimum dimension thresholds; planing the plurality of refractory bricks to a predetermined height; performing, based on the kiln recipe, one or more machining operations to create features within the plurality of refractory bricks; and outputting the plurality of refractory bricks to a storage orientation.

In some aspects, the method further includes rejecting a refractory brick based at least in part on the dimensions of the refractory brick being less than the minimum dimension thresholds. In some aspects, the one or more machining operations include at least one of a groove machining operation, an end beveling operation, a cold face milling operation, or a hole drilling operation. In some aspects, performing the one or more machining operations includes rotating a turret supporting one or more refractory bricks between a plurality of stations for performing the one or more machining operations based on the kiln recipe. In some aspects, performing the one or more machining operations includes: releasably securing a refractory brick to a robotic arm; and causing the robotic arm to position and move the refractory brick past a rotating cutting head to perform a machining operation. In some aspects, the method further includes cleaning the plurality of refractory bricks using an air system prior to outputting the plurality of refractory bricks. In some aspects, outputting the plurality of refractory bricks includes printing identifiers on the plurality of refractory bricks. In some aspects, outputting the plurality of refractory bricks to the storage orientation includes storing the refractory bricks in order for assembly of the kiln based on the kiln recipe.

In some aspects, the techniques described herein relate to a system, including: a conveyance system; a measurement system; one or more rotating cutting heads; one or more processors; and one or more non-transitory computer-readable media having instructions stored thereon that, when executed by the one or more processors cause one or more processors to perform operations including: receiving, at the conveyance system, a plurality of refractory bricks; receiving a kiln recipe describing dimensions and configurations of refractory bricks for assembling into a kiln; determining, using sensor data from the measurement system, that dimensions of the plurality of refractory bricks exceed minimum dimension thresholds; planing the plurality of refractory bricks to a predetermined height using the one or more rotating cutting heads; performing, based on the kiln recipe, one or more machining operations using the one or more rotating cutting heads to create features within the plurality of refractory bricks; and outputting the plurality of refractory bricks to a storage orientation.

In some aspects, the operations further include rejecting, using the conveyance system, a refractory brick based at least in part on the dimensions of the refractory brick being less than the minimum dimension thresholds. In some aspects, the conveyance system includes: an infeed conveyor; a rotating turret; an output conveyor; and one or more transit systems to traverse between the infeed conveyor, rotating turret, and output conveyor. In some aspects, the one or more rotating cutting heads includes: a planing device for machining a height of the plurality of refractory bricks; a beveling device for machining a bevel into ends of the plurality of refractory bricks; a groove forming device to machine grooves for heating elements; and one or more stationary cutting bits. In some aspects, the system further includes an air system configured to clean dust off the plurality of refractory bricks prior to outputting the plurality of refractory bricks.

### BRIEF DESCRIPTION OF THE DRAWINGS

Features of the present disclosure, its nature, and various advantages, may be more apparent upon consideration of the following detailed description, taken in conjunction with the accompanying drawings. The detailed description is set forth below with reference to the accompanying figures. In the figures, the left-most digit(s) of a reference number may identify the figure in which the reference number first appears. The use of the same reference numbers in different figures may indicate similar or identical items. The systems depicted in the accompanying figures are not necessarily to scale and components within the figures may be depicted not to scale with each other.

FIG. 1 illustrates a block diagram of a system for production of refractory bricks, according to at least one example.

FIG. 2 illustrates an infeed station for the system of FIG. 1, according to at least one example.

FIG. 3 illustrates the infeed station of the system of FIG. 2 depicting an input refractory brick being received onto a conveyor, according to at least one example.

FIG. 4 illustrates a measurement and quality control station for the system of FIG. 1, according to at least one example.

FIG. 5 illustrates a transfer system and planing station for transferring refractory bricks from a conveyor system to a planing device and delivering the refractory bricks to a turret of the system of FIG. 1, according to at least one example.

FIG. 6 illustrates the planing station of FIG. 5 with the transfer system positioned adjacent the conveyor system, according to at least one example.

FIG. 7 illustrates the planing station of FIG. 5 after a planed brick has been removed by the turret system, according to at least one example.

FIG. 8 illustrates the planing station of FIG. 5 as a refractory brick is planed to height before being delivered to the turret, according to at least one example.

FIG. 9 illustrates a machining system for machining one or more grooves in a surface of the brick, according to at least one example.

FIG. 10 illustrates a machining system for machining one or more bevels on the refractory brick, according to at least one example.

FIG. 11 illustrates an unloading system for removing bricks from the turret of FIG. 5, according to at least one example.

FIG. 12 illustrates a system for machining one or more features and/or performs special operations with the brick using one or more cutting heads, according to at least one example.

FIG. 13 illustrates the system of FIG. 12 depicting a robotic arm transferring and moving a brick during machining, according to at least one example.

FIG. 14 illustrates the robotic arm of the system depicted in FIG. 12 transferring the machined brick to a transfer shuttle, according to at least one example.

FIG. 15 illustrates a transfer shuttle for receiving bricks from the robotic arm and from the rotating main turret and positioning for machining of additional bevels on ends of the bricks, according to at least one example.

FIG. 16 illustrates the bevel machining system of FIG. 15 prior to machining of the brick, according to at least one example.

FIG. 17 illustrates the bevel machining system of FIG. 15 post-machining of the bevel, according to at least one example.

FIG. 18 illustrates a system for reorienting and outfeeding completed bricks, according to at least one example.

FIG. 19 illustrates the outfeeding system for reorienting the bricks onto an outfeed conveyor, according to at least one example.

FIG. 20 illustrates an outfeed positioning system for loading completed bricks into an organization mode for assembly of a kiln or other equipment, according to at least one example.

FIG. 21 illustrates an example of a kiln assembled using refractory bricks produced by the system described herein, according to at least one example.

### DETAILED DESCRIPTION

The present disclosure is directed, in part, to a brick shaping and production system that provides for quality control, high tolerances, programmable flexibility, and reduced exposure to silicates by operators. Specifically, the systems and devices described herein relate to refractory brick shaping. Refractory brick relates to brick that can withstand high temperatures without the heat damaging their structure, resistance, or thermal conductivity. Refractory brick or fire brick is formed of a ceramic material and is used in furnaces, kilns, fireboxes, fireplaces, and other such environments. Typically, refractory bricks for furnaces and kilns include silica-based fire bricks. Among the many challenges associated with shaping refractory bricks to be used in kiln manufacturing is that the raw refractory bricks, prior to being shaped for assembly into a kiln or furnace wall are manufactured with wide ranging tolerances. Stated refractory brick manufacturing tolerances are +/−one-eighth of an inch. Such low tolerances may result in rectangular bricks placed adjacent one another in a course of a kiln or furnace wall that may differ in height, width, and length by up to one-quarter of an inch. Such gaps and differences in brick shapes and sizes makes assembly of a tightly-sealed kiln extremely difficult or impossible without resizing each brick to ensure that the bricks are of a consistent shape and size and/or that the bricks have high tolerances to ensure a tight fit to provide for a tightly-sealed kiln or furnace wall. Kiln walls or furnace walls that are not tightly-sealed allow heat to pass through the refractory lining, are less efficient, and more prone to damage and shortened lifespan.

Furthermore, refractory bricks may include voids, cracks, edge chips, holes, and other defects that may be exposed during shaping operations. Therefore, the refractory bricks must be analyzed and verified for quality control parameters while shaping. The systems and devices disclosed herein are configured for detecting and rejecting bricks for a variety of defects that would otherwise require manual inspection by a human operator during a shaping process.

The systems and devices described herein also provide for shaping and machining a variety of types and configurations of refractory bricks without requiring re-tooling or setup. Therefore, the systems are capable of producing a variety of brick types as needed. In this manner, the bricks may be produced and immediately stacked or placed on a pallet for delivery without requiring batches of different types of bricks to be stored and re-sorted into collections for an individual kiln. The systems and devices described herein provide for manufacturing each of the bricks needed for a single kiln and then turning to manufacturing of bricks for a second kiln. The disclosed systems and devices are also configured to produce bricks in typical batch orders, for fulfillment systems that require batches of a particular type of brick. Therefore, the systems and devices described herein no longer require shaping many of the same kind or configuration of brick in batches for efficiency.

In an example, a given kiln requires upwards of six or more different shapes of bricks with varying features. Thus, a batch approach to manufacturing necessitates inventorying of large quantities of brick from which a kiln order can be pulled. In light of the instant disclosure, pulling the bricks for a kiln order, which is a further time-intensive process, is no longer needed as the order of kiln bricks can be produced directly as needed in the order needed for assembly of the kiln. In an example, the refractory bricks may be produced and stacked on a pallet in a reverse order of assembly, with the first bricks to be used in assembling the kiln being the last bricks produced on the pallet. Therefore, when the kiln bricks arrive at a destination, the assembler may pick the bricks in order and build up the kiln without having to sort or stage the bricks.

Given the fragile nature of the bricks and the requirement to transport refractory bricks to and from inventory as well as to sort them during assembly results in a high percentage of damaged brick and high scrap rates. The systems and devices described herein provide for production of brick shapes with requisite features that are needed for a specific kiln order and produces them in the order needed to assemble the kiln, thus eliminating the need to take the bricks to storage and subsequently retrieve finished bricks from inventory.

Further still, the systems and devices described herein provide for a safer assembly process that reduces operator exposure to silica dusts and chunks of refractory that may need to be retrieved from manufacturing stages. Traditional brick shaping methods employ saws to create bevels on the bricks that result in chunks of refractory material in addition to fine dust. These chunks of refractory may become problematic with continuous operation and often create hazards for operators as they are retrieved from sawing equipment and then transported away from the manufacturing area for disposal. The systems and devices described herein use grinding and machining techniques that turn all removed material into fine dust that is immediately collected in a dust collection system such that the manufacturing process is clean, safe, able to operate continuously, and significantly reduces exposure to silica dusts for operators.

In an example of the present disclosure, the systems and techniques described herein relate to a production system for refractory bricks, the production system including: an infeed component that receives and orients the refractory bricks in a consistent manner; a quality control component that receives the refractory bricks from the infeed component and measures and visually inspects the refractory bricks, wherein refractory bricks failing the quality control component are rejected; a planing component that receives accepted the refractory bricks from the quality control component and planes the refractory bricks to a uniform height; a machining component that receives planed refractory bricks and performs one or more operations according to a brick recipe defining a shape for the refractory bricks; a bevel component that adds a bevel to edges of the refractory bricks; a transfer system including one or more conveyors, robotic arms, turrets, transfer shuttles, and other such conveyor systems to transport refractory bricks between components in an automated fashion; and a control system that receives a brick recipe describing a final shape for a brick and controls operation of the components to produce the final shape.

In an example of the present disclosure, the techniques described herein relate to a method including: receiving, at an infeed conveyor system, a plurality of refractory bricks; receiving, at a controller, a kiln recipe describing dimensions and configurations of refractory bricks for assembling into a kiln; determining, using sensor data from a sensor system, that dimensions of the plurality of refractory bricks exceed minimum dimension thresholds; planing the plurality of refractory bricks to a predetermined width; performing, based on the kiln recipe, one or more machining operations to create features within the plurality of refractory bricks; and outputting the plurality of refractory bricks to a storage orientation.

In an example of the present disclosure, the systems and techniques described herein relate to a system, including: a conveyance system; a measurement system; one or more rotating cutting heads; one or more processors; and one or more non-transitory computer-readable media having instructions stored thereon that, when executed by the one or more processors cause one or more processors to perform operations including: receiving, at the conveyance system, a plurality of refractory bricks; receiving a kiln recipe describing dimensions and configurations of refractory bricks for assembling into a kiln; determining, using sensor data from the measurement system, that dimensions of the plurality of refractory bricks exceed minimum dimension thresholds; planing the plurality of refractory bricks to a predetermined height using the one or more rotating cutting heads; performing, based on the kiln recipe, one or more machining operations using the one or more rotating cutting heads to create features within the plurality of refractory bricks; and outputting the plurality of refractory bricks to a storage orientation.

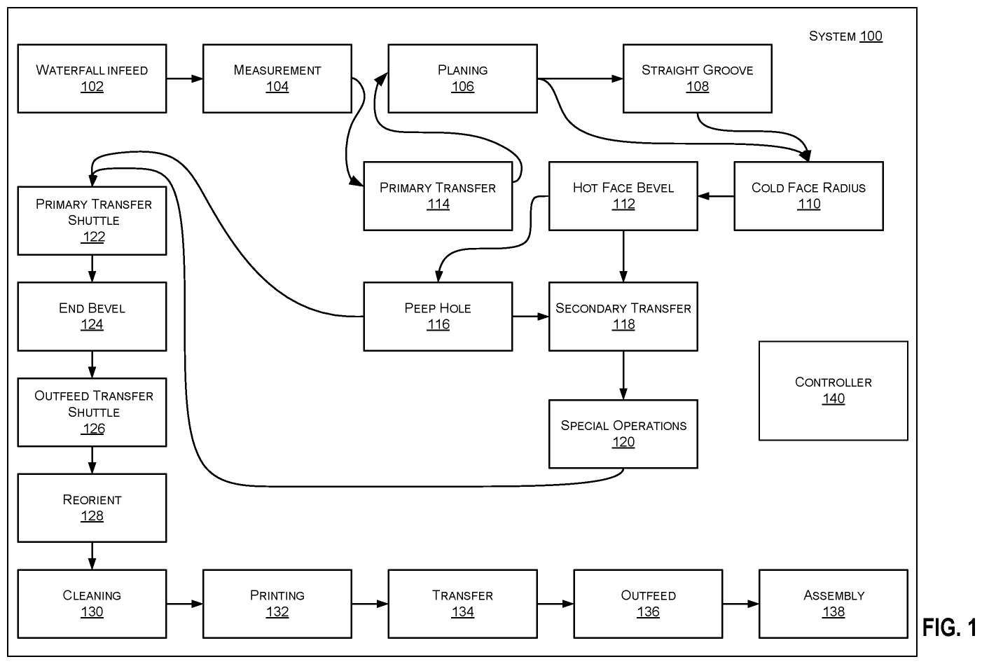

FIG. 1 illustrates a block diagram of a system 100 for automated production of refractory bricks as controlled by a controller 140, according to at least one example. The system 100 may perform one or more operations as controlled by a controller 140, which may include a Programmable Logic Controller (PLC), or other such controller device, with embedded motion control functionality. The controller 140 allows each brick shaping operation to be defined digitally through software means that is in turn guided by a recipe for a particular kiln, furnace, or other implementation. Therefore, the controller 140 may be used to produce bricks of any shape and configuration as defined by software with no need for tooling changes in order to create the desired kiln brick shape. This allows the production of any kiln model, furnace model, or replacement bricks (or any individual brick required for a kiln model) by simply selecting the model or the brick part from a recipe database. Alternately, the controller 140 can communicate with a factory system to download required kiln production for the subsequent operational shift. This eliminates the need for shaped kilns to be stored in inventory. This also allows for the production of kiln bricks in the order needed to assemble the kiln in the most efficient manner. The system 100 illustrates steps in a process carried out by an automated system that eliminates the need for direct operator contact with the brick shaping process thereby significantly reducing exposure of personnel to high silicate concentrations associated with the brick dust.

Though the system 100 is shown as a system that is configured to perform the operations shown and described herein, in some examples one or more of the operations may be performed or may not be performed on some number of the bricks produced, for example with some operations performed in a different manner depending on the specific design of a refractory brick with the unique geometry required for interfacing with other elements such as ports, heating elements, other refractory bricks, and other such features of a final component. Accordingly, one or more of the operations shown and described herein may be performed or not performed and may be skipped by traversing the particular step or operation during processing of a particular brick. The controller 140 enables a customizable approach that enables production of a full run of components for assembly of a single kiln, for example, without requiring changes in tooling or configuration as the controller 140 controls the system 100 to cause each brick to be produced as required and in an assembly order such that the final kiln may be rapidly and efficiently assembled, minimizing handling of the final refractory bricks.

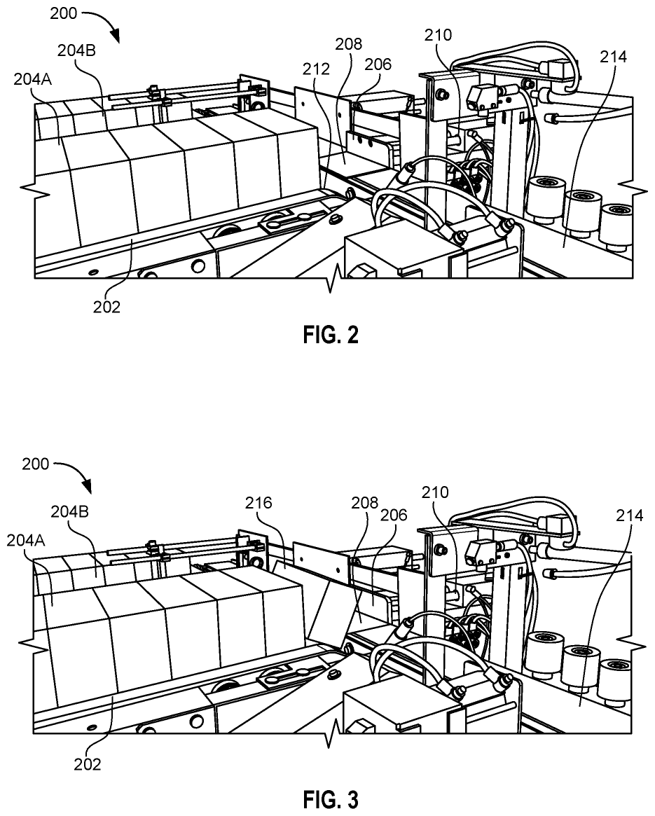

The system 100 includes a waterfall infeed 102 that is described in further detail with respect to the system depicted in FIGS. 2-3 herein that allows two or more different brick thicknesses to be buffered at the input of the production cell. Bricks are oriented on a conveyor system to maximize a density of bricks on the conveyor with a narrow edge of the bricks down on belt of a conveyor system on the infeed. The bricks may then be re-oriented as they are transferred into the system 100 via a waterfall action that places the brick wide edge down for subsequent shaping operations.

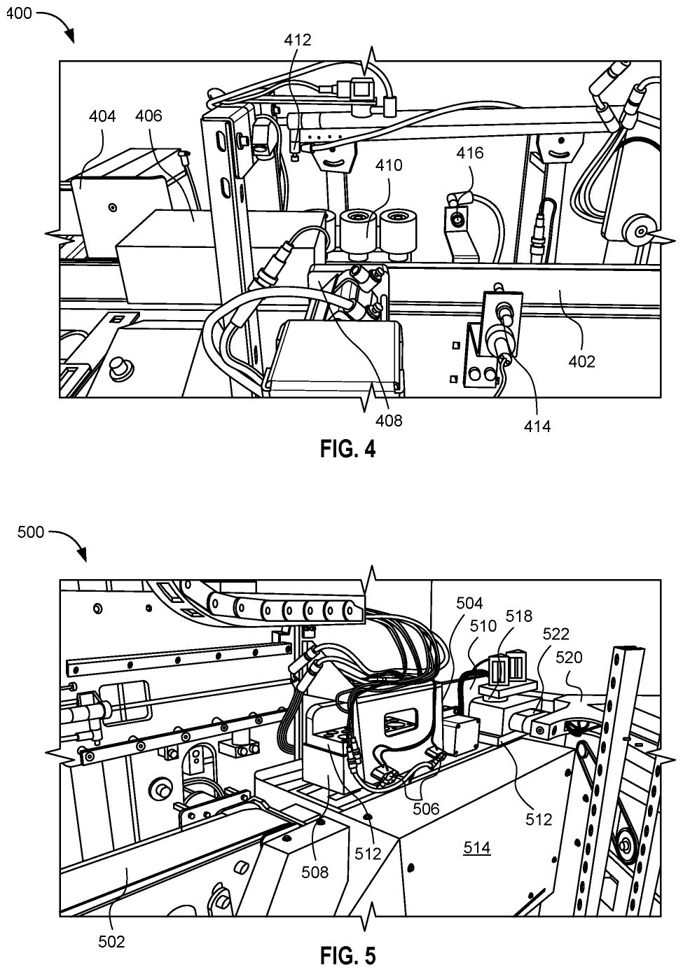

The system 100 further includes a measurement system 104 as depicted in FIG. 4 that measures width, height, and length of the bricks to ensure that it meets a minimum dimensional size from which a kiln brick may be shaped. The measurement system 104 may include a system for rejecting bricks that do not meet minimum dimensions. The measurement system 104 may also include functionality for performing evaluation of the bricks, for example with optical sensors (e.g., cameras) to detect flaws, cracks, or chips in the bricks that may make them unsuitable for production. The measurement may be performed using contact and/or non-contact sensors. Bricks that are undersized or otherwise out of tolerance or specification may be rejected at the measurement system 104. The bricks may be visually inspected with a camera system to identify chips, voids, cracks, and other issues that would prevent further use. In some examples, the measurement system 104 may also perform inspection using x-ray or other inspection tools to identify cracks, defects, or other flaws in the refractory bricks.

The bricks proceed from the measurement system 104 to a planing station 106. The planing station 106 is depicted and described with respect to FIGS. 5-8 and may include a system to transfer bricks to a planing turret that secures the bricks in position and rotates them past a planing cutter-head. The cutter-head or multiple cutter-heads plane the sides of the brick such that the bricks are of a consistent and identical height for uniform stacking of a gap free kiln. In some examples the thickness may be configurable to enable planing of some bricks to a different thickness than other bricks.

The system 100 includes a brick shaping turret that may include multiple stations to produce various features in the bricks. The turret is shown and described with respect to FIGS. 5-8 herein. Some bricks may receive one or more of the features, and some bricks may receive none of the features. The controller may use a “Kiln Recipe” that tracks and controls operations to shape each brick as needed for producing a completed kiln. The kiln recipe may include the shapes, dimensions, and features of the various kiln bricks and also may include an order of assembly of the components such that the kiln bricks may be produced in a sequence that enables assembly with minimal handling of the kiln bricks. In an example, the kiln recipe may include a sequence for assembling the components such that a pallet or other storage configuration of the kiln components is stacked with the first components to be used (e.g., to assemble the base) positioned at the top of the stored configuration. The kiln bricks may then be arranged in order such that the kiln may be assembled in order directly from the pallet or stored configuration.

A straight groove component 108, such as shown and described with respect to FIG. 9 cuts straight grooves for electrical heating elements. The shaping process is managed by a plurality of cutters that create “P-shaped” groove in a “hot face” surface (e.g., a surface that faces an interior of the kiln when assembled) within which one or more heating elements may be housed. In some examples, when straight grooves are not needed as in the case of a “terminal block brick,” the brick passes through this station without any shaping operations being conducted.

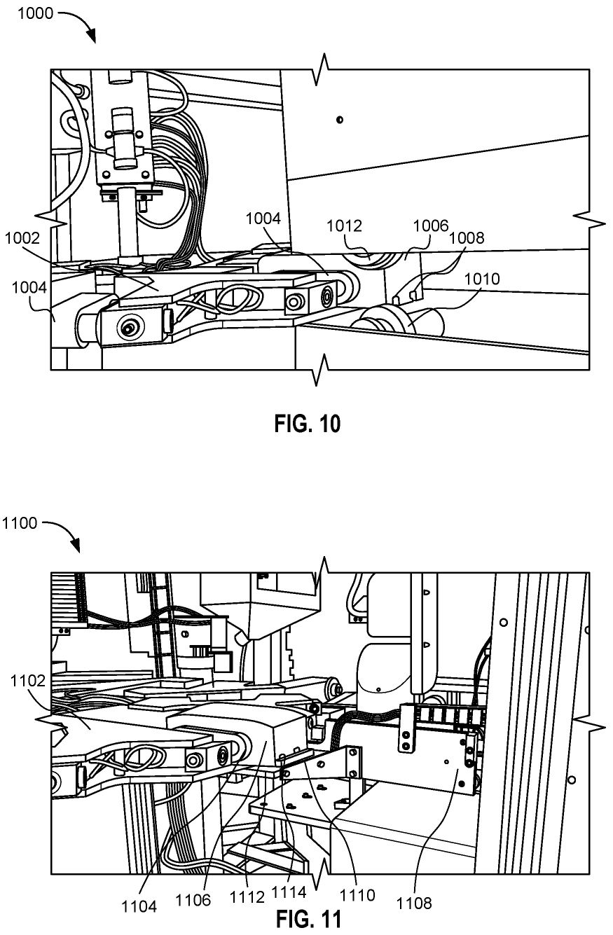

The brick shaping turret further includes a cold face station 110 and a hot face bevel 112 as depicted in FIG. 10. In these stations the “cold face” outward facing surface is shaped with a software-defined radius to facilitate a smooth kiln exterior that can be wrapped with a stainless-steel sheet cover. Also, the inner “hot face” surface receives a bevel grind for improved edge chip resistance and optimum thermal sealing purposes. In some examples, all bricks passing through the system 100 may receive this shaping operation.

The brick shaping turret may further include a peep hole station 116 that drills a tapered hole into the brick when needed. This feature is managed by the controller 140 according to the “Kiln Recipe” and typically only one brick per layer of a kiln receives this tapered hole.

The brick shaping turret further includes a primary transfer station as shown in FIG. 11 that releases the brick from the turret onto an outfeed shuttle when all shaping operations being done to the brick are complete. This transfer is managed by the controller 140 according to the “Kiln Recipe.” If additional shaped features are required that may be performed at the turret, the brick may be retained by the turret clamps and continues to a secondary transfer station 118.

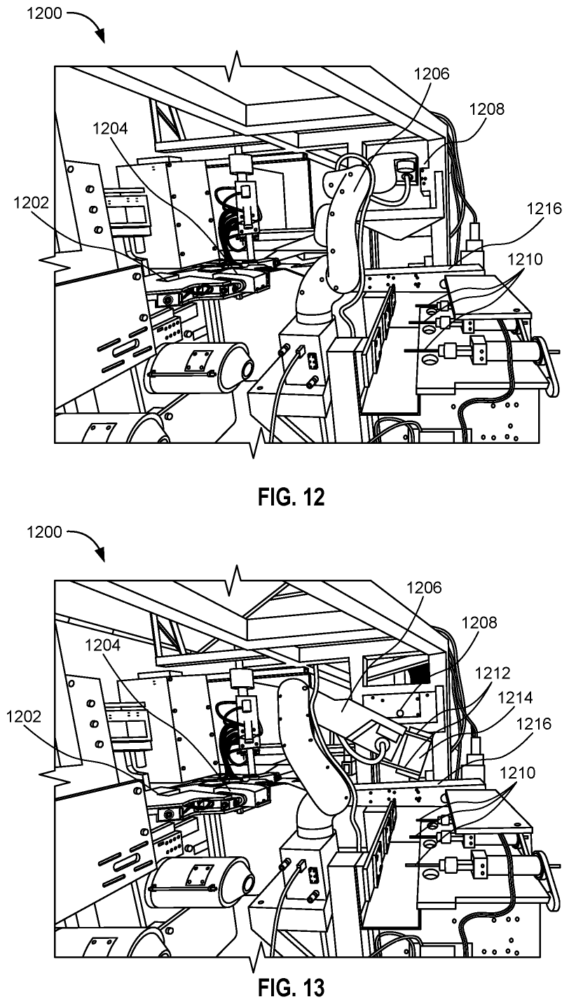

At the secondary transfer station 118, the brick is provided to a special operation component 120 if additional features are needed. These features may include features such as terminal block grooving with subsequent heating element conductor drilled pass-thru holes. Also, this secondary transfer station 118 manages drilling of thermocouple access holes, and ancillary holes as depicted in FIGS. 12-14 that include operations for clearing dust and debris off the bricks by “shaking” or tilting using the robotic arm. These features are managed by the controller 140 according to the “Kiln Recipe.” The robotic cell for the special operation component 120 may have an infeed conveyor that receives the brick from the secondary transfer station 118. The robot picks the brick up off the conveyor and guides the brick through a path engaging a router bit or other machining tool that shapes a transition groove in the brick allowing the heating element path to transition from an upper groove to a lower groove within a kiln brick “layer”. Also, holes may be drilled at the termination points of the heating element path to allow the heating element conductors to pass through the brick to the outer surface for connection to a controller. Once all robotic cell operations are complete, the robot places the brick onto the primary transfer shuttle 122 that receives the brick from the primary transfer station 114 on the turret or from the robot and shuttles the brick to the end bevel station 124.

The end bevel station 124 as depicted in FIGS. 15-17 and moves the brick past rotating carbide cutting drums, then reverses directions and raises the brick between the rotating drums. As the brick is moved, the drums move horizontally inward toward the brick machining a bevel into the brick ends. The angle of the bevel is defined by the kiln recipe. The angle may be a compound angle that allows a slight gap at the hot face allowing brick face expansion due to thermal growth as the kiln heats up without creating a gap between adjacent bricks. Once the brick ends are beveled—the brick is released to an outfeed transfer shuttle 126 that receives the brick from the end bevel station and places the brick onto an outfeed roll case. The outfeed roll case allows gravity feed of the brick to the brick reorient station 128.

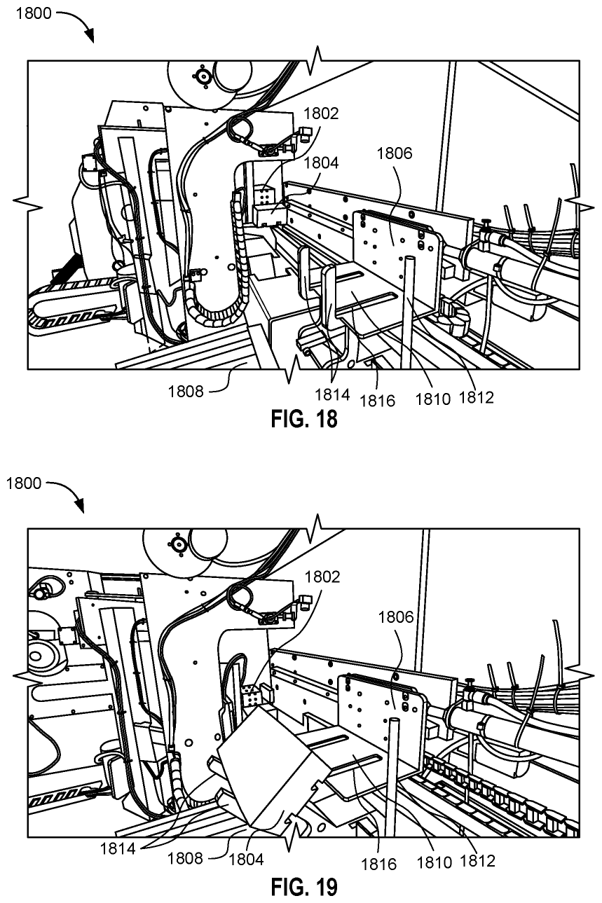

The brick reorient station 128 depicted in FIGS. 18-19 receives the brick and then transfers it to the outfeed roll case by rotating it downward 90 degrees and setting it down gently. This allows the brick to travel to the outfeed conveyor on its “bottom surface” thus avoiding damage to the inner kiln brick surface. The kiln brick is transferred to the brick cleaning station 130 via a narrow conveyor.

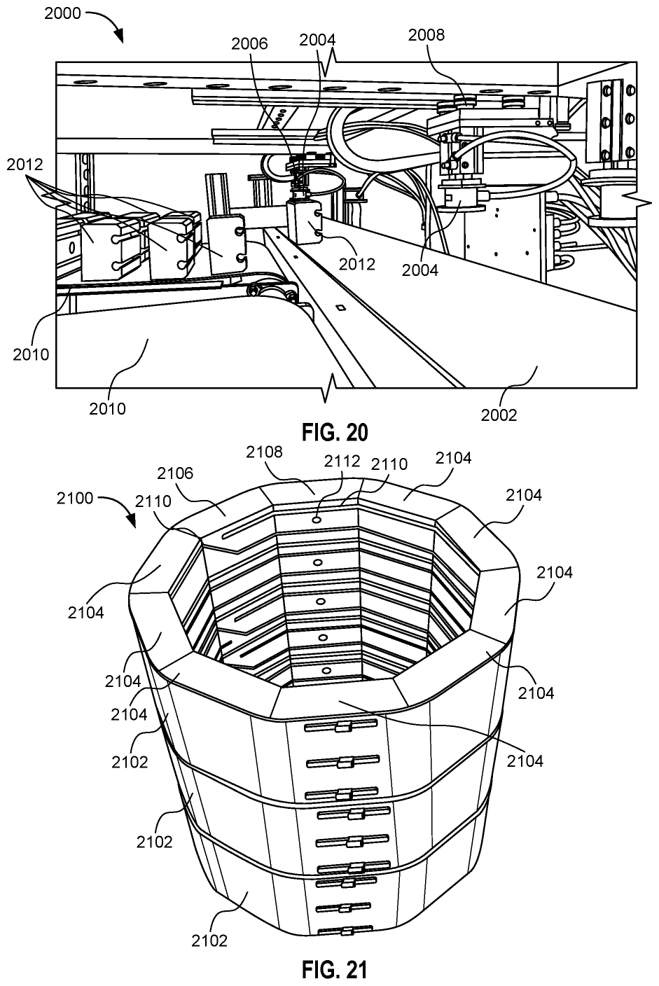

The brick cleaning station 130 may be associated with an outfeed system, such as depicted in FIG. 20, or may include a separate station that is fitted with pneumatic nozzles and dust collection hood to remove the majority of dust from the brick as it travels through this station to the brick printing station 132, also shown in FIG. 20. The brick printing station 132 prints the brick part number and any other relevant information on the brick as the brick proceeds to the brick transfer unit 134. The brick transfer unit 134 senses the brick location and picks up the brick with a Bernoulli gripper and transfers the brick from the narrow conveyor and places it onto the outfeed conveyor 136 from which the kiln bricks will be taken in kits to build complete kilns at assembly 138. An example of a completed kiln is depicted in FIG. 21.

FIG. 2 illustrates an infeed station 200 for the system of FIG. 1, according to at least one example. The infeed station 200 comprises one or more infeed systems for receiving refractory bricks. In an example, a conveyor 202 may be used to carry an inlet stream of refractory bricks 204A and a second conveyor (not shown) may be used to carry a second inlet stream of refractory bricks 204B. The infeed conveyors may carry refractory bricks of different dimensions, for example with the refractory bricks 204A may be of a first thickness and the refractory bricks 204B may be of a second thickness. The infeed station 200 may therefore be used to provide refractory bricks of different sizes based on the needs of a particular kiln recipe or particular requirements.

The infeed station 200 includes a waterfall catch 206 with a base 208 to receive refractory bricks 204A as they tilt off the end 212 of the conveyor 202. The waterfall catch 206 with the base 208 is actuated by an actuator 210 to advance perpendicular to a conveyor 214 that carries the refractory bricks into the processing system for measurement and machining and other operations as described herein.

During operation, the waterfall catch 206 advances forwards towards the end 212 of the conveyor 202 to catch the refractory bricks as they tilt off the end 212 of the conveyor 202. As depicted in FIG. 3, a refractory brick 216 advances from the conveyor 202 to the conveyor 214. In this manner, the refractory brick 216 tilts from a first edge onto a second edge for laying on the conveyor 214. This enables the refractory bricks to be stacked in a space efficient manner on the conveyor 202 and then be processed on the conveyor 214 as needed. The waterfall catch 206 advances by the actuator 210 after receiving the refractory brick 216 to place the refractory brick 216 on the conveyor 214. The waterfall catch 206 then advances, by the actuator 210, away from the conveyor 202 to leave the refractory brick 216 on the surface of the conveyor 214.

FIG. 4 illustrates a measurement and quality control station 400 for the system 100 of FIG. 1, according to at least one example. The measurement and quality control station 400 is positioned downstream of the infeed station 200 along the conveyor 214. The conveyor 402 may be the conveyor 214 or may be a separate conveyor that receives refractory bricks from the conveyor 214. The measurement and quality control station 400 is shown with an infeed station 404 adjacent the conveyor 402 that may be an example of the infeed station 200 of FIG. 2.

The measurement and quality control station 400 receives a refractory brick 406 on the conveyor 402. For consistency and accuracy of measurement, the refractory brick 406 is positioned by the measurement and quality control station 400 to a particular location on the conveyor 402. The positioning enables accuracy and repeatability of measurements and also provides for the refractory bricks to be consistently positioned for subsequent stations down the line of the system 100. The positioning is accomplished by a pusher 408 and rollers 410. The pusher 408 provides a linear actuator to apply a force against the refractory brick 406 and slide the refractory brick 406 on the conveyor 402 to contact the rollers 410. The refractory brick 406 is measured by sensors including sensor 412, sensor 414, and sensor 416. The sensors may include optical, laser, and other non-contact or contact based sensors that provide sensor data to the controller 140 for determining the dimensions of the refractory brick 406 to a degree of accuracy required for a particular implementation. The consistency and repeatability of the measurement and quality control station 400 enables high levels of accuracy and consistency during production of kilns. The sensors may also include one or more cameras to gather image data for evaluation of the quality of the refractory brick 406. The image data may be processed at the controller 140 or an associated computing device to evaluate the refractory bricks for cracks or other flaws that may impact the usefulness of the refractory brick in an installation. In some examples, the sensors may include non-contact sensors such as ultrasound and/or x-ray sensors for providing visibility into the internals of the refractory bricks to identify voids, internal defects, cracks, or other such flaws.

The measurement and quality control station 400 may include a rejection system (not shown in FIG. 4) that provides for rejection and/or removal of a refractory brick 406 if flaws are detected using the sensors and/or if the dimensions of the refractory brick 406 are below one or more thresholds for height, thickness, or length based on the final dimensions of a particular final brick produced by the system 100. The rejection system may remove the refractory brick from the conveyor 402 in response to the controller 140 determining that the refractory brick is deficient in one or more parameters. The refractory brick 406 may then be removed and may be used for different installations or other uses.

FIG. 5 illustrates a system 500 including a transfer system 504 and planing station 514 for transferring refractory bricks from a conveyor 502 to a planing device and delivering the refractory bricks to a turret that may be used to deliver the refractory brick between various stations for different shaping operations, according to at least one example. The conveyor 502 brings the refractory bricks from a measurement and quality control system such as shown and described in FIG. 4, and transfers the refractory brick 508 from the conveyor 502 onto a planing turret 510. The transfer system 504 includes a carriage with actuators 506 to clamp the refractory brick 508 and remove the refractory brick 508 from the conveyor 502 and subsequently accurately position the refractory brick 508 on the planing turret 510. The planing turret 510 clamps the refractory brick 508 between a platform 512 and actuators 518. This clamping enables the planing station 514 to plane the edges of the refractory brick 508 to provide a consistent and accurate height of refractory brick after the planing operation.

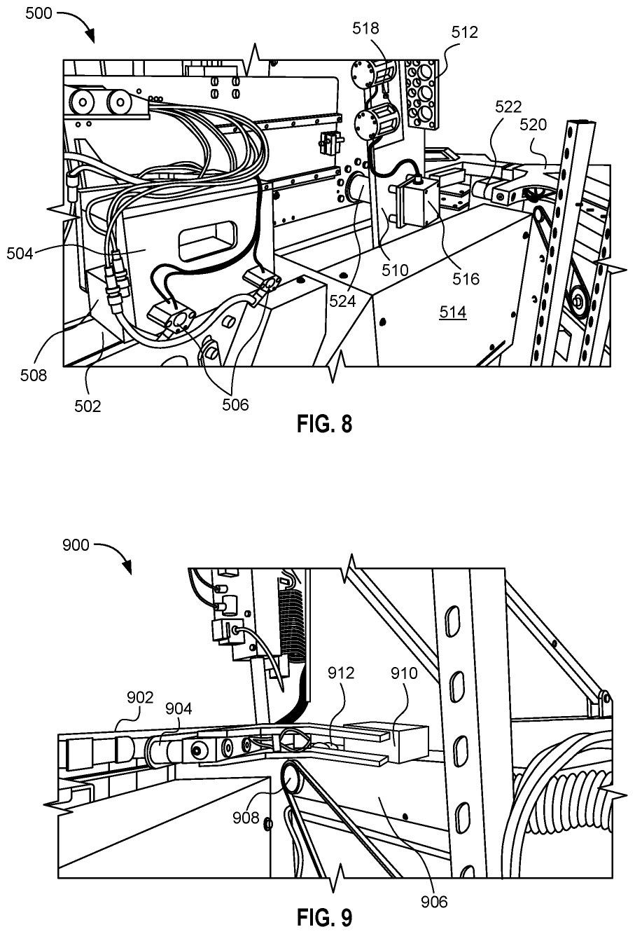

The planing station 514 includes rotating cutters (not shown) that grind or surface the edges of the refractory brick 508 as the planing turret 510 is rotated by motor as depicted in FIG. 8. The planing turret 510 has two platforms for securing one refractory brick at each end of the planing turret 510. The planing turret 510 is rotated by the motor 516 to carry the refractory brick 508 over and/or through the cutting heads as the refractory brick transits from the conveyor to the turret 520. As depicted in FIG. 8, the planing turret 510 is rotationally connected to a support through an axle 524 and driven by the motor 516 to alternate the platforms 512 being at the turret 520 and adjacent the conveyor 502.

Returning to FIG. 5, the refractory brick 508 is clamped at the turret 520 by actuators 522 that are perpendicular to the actuators 518 used to secure the refractory bricks 508 to the planing turret 510.

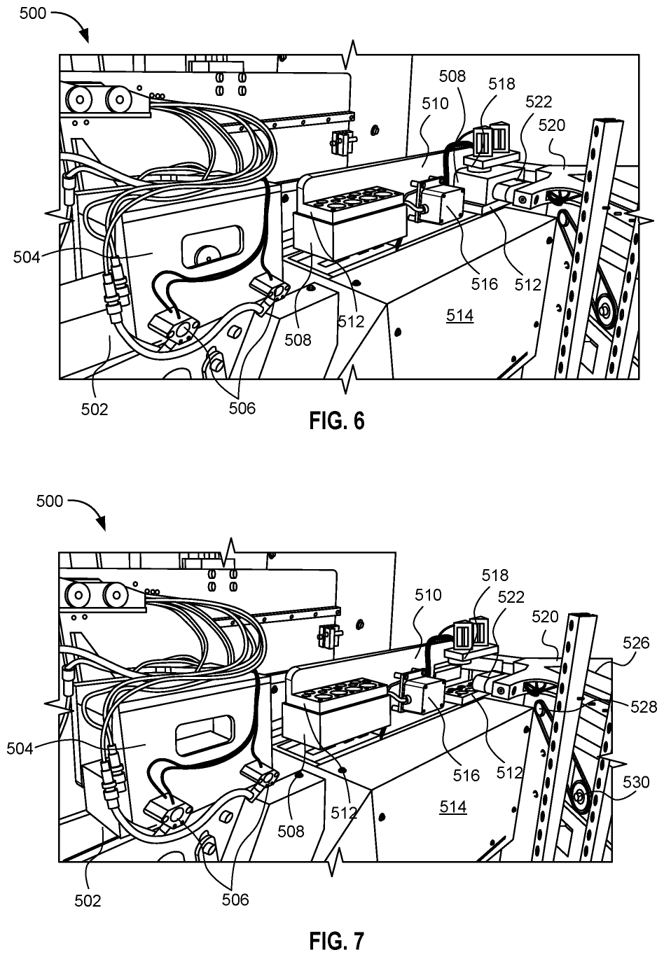

FIG. 6 illustrates the planing station of FIG. 5 with the transfer system positioned adjacent the conveyor system, according to at least one example. The transfer system 504 is moved away from the planing turret 510 by actuators along a rail or other system to clear space for the rotation of the planing turret 510. The refractory brick 508 is shown clamped against the platform 512.

After the refractory brick is planed to the correct height, it reaches the turret 520 where it is clamped in position by the actuators 522. FIG. 7 illustrates the planing station of FIG. 5 after a planed brick has been removed by the turret 520, according to at least one example. The turret 520 receives the refractory brick 508 and rotates to move the refractory brick to a second position of the turret 520 where additional processing may be performed. The example shown in FIG. 7 illustrates a station 526 that may perform a thicknessing operation and/or groove milling operation into a surface of the refractory brick 508. The station 526 includes a cutting head 528 driven by a motor 530 to perform the groove milling operation as shown and described with respect to FIG. 9.

FIG. 9 illustrates a machining system 900 for machining one or more grooves in a surface of the refractory brick, according to at least one example. The machining system 900 may be positioned adjacent to the turret 520, which is illustrated in FIG. 9 as turret 902 with clamping elements 904. The turret 902 rotates such that the refractory brick is aligned with the cutters 912 on a shuttle 906. The shuttle advances forward when the refractory brick is in position to machine grooves using the cutters 912 driven by a motor operatively coupled to shaft 908 in brick 910. The grooves may be grooves for heating elements to rest within when the kiln is assembled. In some examples, the refractory bricks that include straight grooves such that the motion of the shuttle 906 defines the axis of the grooves machines in the refractory brick.

FIG. 10 illustrates a machining system 1000 for machining one or more bevels on the refractory brick, according to at least one example. The machining system 1000 may be similar to the machining system 900 of FIG. 9 with the cutters 1010 and 1012 configured to machine bevels onto the ends of the refractory brick 1006. The machining system 1000 is positioned adjacent the turret 1002 with the clamps 1004 used to secure the refractory brick 1006 in position. The cutters 1010 and cutters 1012 are positioned to machine bevels or rounded corners onto a top and bottom surface of the refractory brick as it is positioned in the turret 1002. The refractory brick 1006 is shown with grooves 1008 from the machining system 900 of FIG. 9 that extend along a length of the refractory brick 1006. In some examples the machining system 1000 may include or may engage only one of the cutters 1010 or the cutter 1012 to bevel or round only either the top or bottom surface of the refractory brick 1006.

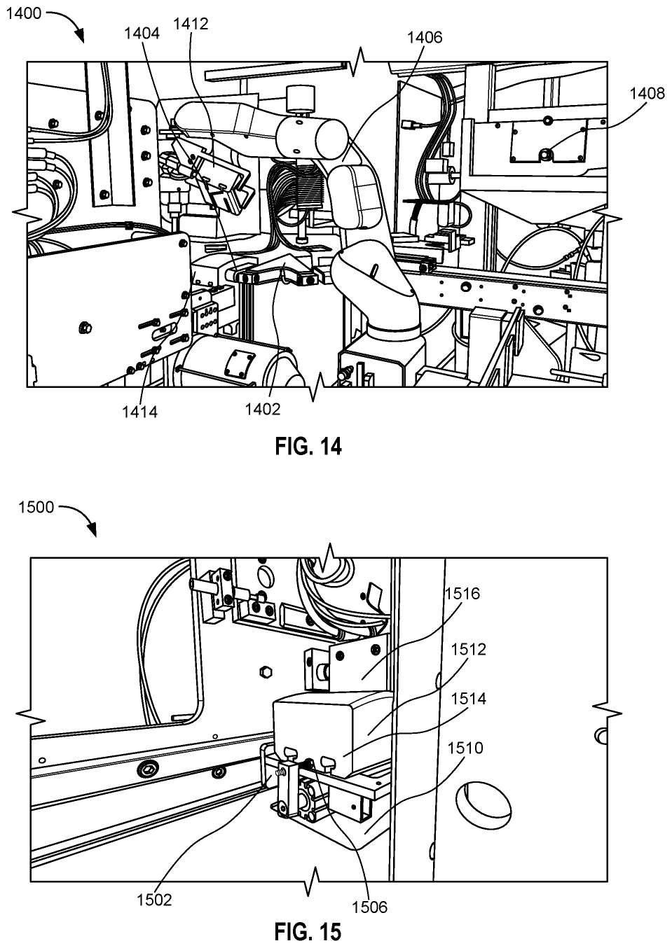

FIG. 11 illustrates an unloading system 1100 for removing bricks from the turret 1102 of FIG. 5 and from the robot special operations of FIG. 14, according to at least one example. The turret 1102 clamps the refractory brick 1106 with the clamps 1104. The refractory brick 1106 is shown after being beveled, shaped, or otherwise machines, and having grooves machined therein as shown with respect to FIGS. 9-10 herein. The unloading system 1100 may be used to remove refractory brick 1106 from the turret 1102 after one or more machining operations are completed at the stations of the turret 1102. Though example stations of the turret are shown and described herein, additional stations may be positioned around the turret 1102 to perform additional machining operations as needed by a particular kiln recipe. In examples, the refractory brick 1106 may be machined at one or more stations and may skip one or more stations or not be processed at one or more stations based on the requirements of the kiln recipe.

The unloading system 1100 includes a shuttle 1108 that advances a platform 1112 attached to the shuttle 1108 with a support 1110. The platform 1112 includes a stop 1114 that may interact with the refractory brick 1106 as the platform 1112 is slid underneath the refractory brick 1106. The refractory brick 1106 may then be unclamped by the clamp 1104 so that the refractory brick 1106 can be moved by the unloading system 1100.

FIGS. 12-14 illustrates a system 1200 for machining one or more features into the brick using one or more cutting heads, according to at least one example. The system 1200 may receive a refractory brick from the secondary transfer system 1216 as the refractory brick 1214 is removed from the turret 1202 after the clamp 1204 is released. The system 1200 includes a robotic arm 1206 such as a pick and place arm or other such robotic arm that retrieves the refractory brick 1214 from the secondary transfer system 1216, specifically from the secondary transfer system 1216. The robotic arm 1206 may then transport the refractory brick to a stationary rotating cutter 1208 and/or an array of rotating cutters 1210 for performing various machining operations into the refractory brick 1214. The robotic arm 1206 controls the motion of the refractory brick 1214 and thereby may form different profiles, holes, and different profiles into the surfaces of the refractory brick 1214. The stationary rotating cutter 1208 and/or the rotating cutters 1210 may be used to cut grooves for heating elements, holes for access, pilot holes, and other such profiles as defined by the kiln recipe. Accordingly, as with the turret stations, the processes performed by the system 1200 may use one or more of the different cutters for different profiles into the refractory brick 1214. The robotic arm places bricks onto the unloading system 1100 of FIG. 11 when special operations are completed, per a kiln recipe.

FIG. 13 illustrates the system of FIG. 12 depicting a robotic arm 1206 transferring and moving a refractory brick 1214 during machining from the stationary rotating cutter 1208 to the rotating cutters 1210, according to at least one example. The robotic arm 1206 grasps the refractory brick 1214 using clamps 1212 that secure the refractory brick in position during the machining operations.

FIG. 14 illustrates a system 1400 such as the robotic arm of the system depicted in FIG. 12 transferring the machined refractory brick to a transfer shuttle, according to at least one example. The system 1400 is depicted with a turret 1402 and clamp 1404 such as described herein. The system 1400 also includes a robotic arm 1406 and shows stations for machining the refractory brick 1412 and/or the refractory brick 1414. The stationary rotating cutter 1408 is depicted as described herein. Accordingly, the stations around the turret enable a compact footprint for the system 1400 to provide the ability to machine any combination of features into refractory bricks 1412 and 1414 as required by the kiln recipe.

FIG. 15 illustrates a transfer shuttle 1500 for receiving bricks from the robotic arm 1406 and from the unloading position of the turret 1102 of FIG. 11 and positioning for machining of additional bevels on ends of the bricks, according to at least one example. The refractory brick is brought into position above the opening 1510 for the bevel machining to take place by the transfer shuttle 1500 by moving the platform 1502 along a rail 1508. The first bevels provided by the bevel system may include bevels on the large surfaces that run the length of the refractory brick 1512. The transfer shuttle 1500 may be used to provide bevels on the ends 1514 of the refractory brick 1512 to enable the refractory bricks 1512 to be stacked to form an enclosed perimeter for a kiln. The transfer shuttle 1500 includes a platform 1502 that receives the refractory brick 1512 from the robotic arm 1406 and the turret 1102 of FIG. 11, and includes a stop 1506 for accurate and repeatable positioning of the refractory brick 1512 on the platform 1502. The platform 1502 is actuated by an actuator (not shown in FIG. 15) that moves the platform from a first horizontal position where the turret releases the brick to the transfer shuttle, to the second horizontal position where the robotic arm releases the refractory brick 1512 to a third position adjacent an opening 1510 for a bevel machining system. The transfer shuttle 1500 also includes a vertical positioning system 1516 that clamps the refractory brick 1512 to move the refractory brick 1512 vertically to enable the cutters to cut bevels into the ends 1514 of the refractory brick 1512.

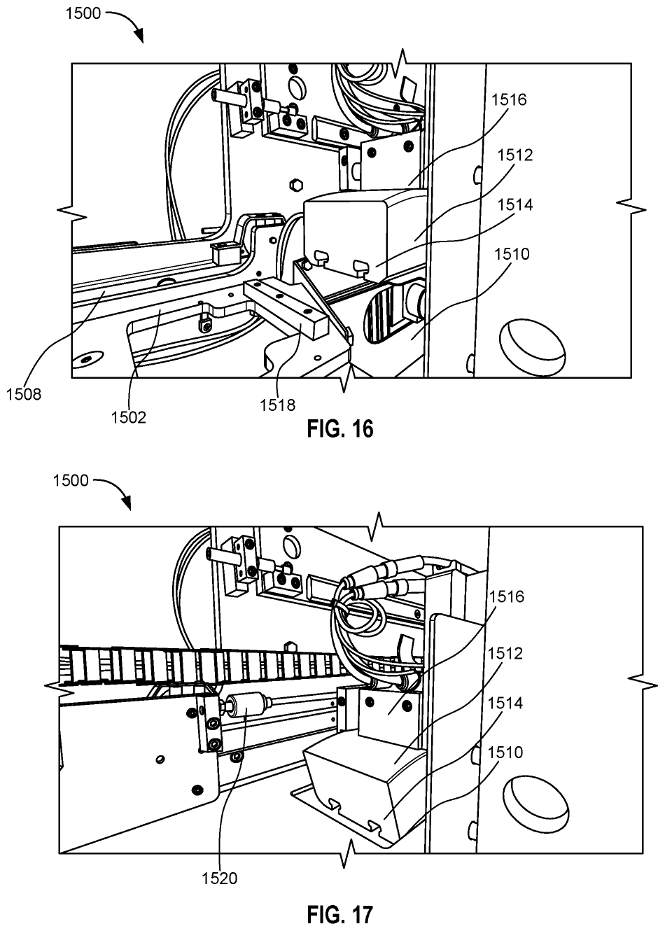

FIGS. 16-17 illustrate the transfer shuttle 1500 of FIG. 15 prior to and after machining of the bevels into the ends 1514 of the refractory brick 1512, according to at least one example. The refractory brick 1512 is positioned over the opening 1510 enclosing the cutters for the bevel machining and the platform 1502 is moved along the rail 1508 out of the way of the refractory brick 1512. The platform includes a stop 1518 that provides accurate forward and backwards positioning of the refractory brick 1512 on the platform 1502. After the platform 1502 is moved out of position by an actuator 1520, the vertical positioning system 1516, that clamps onto the refractory brick 1512, moves the refractory brick 1512 through the opening to have the bevels machined in the ends of the refractory brick, as depicted in FIG. 17.

FIG. 18 illustrates a system 1800 for reorienting and outfeeding completed bricks, according to at least one example. The system 1800 includes a shuttle 1806 that moves laterally with the refractory brick 1804 and also receives the refractory brick after one or more machining processes are completed, such as the bevel shaping process, and moves the refractory brick 1804 laterally to an outfeed station. At the outfeed station, the refractory brick 1804 is tilted off the shuttle 1806 to a conveyor 1808. The refractory brick 1804 is oriented to stand on an edge surface on the conveyor 1808 similar to the orientation on the infeed conveyor systems described herein, prepared for stacking at a storage position.

The shuttle 1806 includes a platform 1810 on which the refractory brick 1804 rests after being released by a shuttle 1802. Adjacent the platform 1810 is a stop 1812 to prevent the refractory brick 1804 from proceeding beyond the platform 1810. The platform 1810 defines cutouts 1816 for support arms 1814 to cradle and tilt the refractory brick off the platform 1810 onto the conveyor 1808. The support arms 1814 may have an L-shape that passes through the cutouts 1816 to begin rotation of the refractory brick 1804 and also includes a vertical portion to support the refractory brick as it is rotated such that the rotation is at a controlled speed to prevent damage to the refractory bricks. FIG. 19 illustrates the system 1800 with the refractory brick 1804 mid-rotation as it is repositioned onto the conveyor 1808.

FIG. 20 illustrates an outfeed positioning system 2000 for loading completed bricks into an organization mode for assembly of a kiln or other equipment, according to at least one example. The outfeed positioning system 2000 includes a conveyor 2002 which may be the same or similar to the conveyor 1808 of FIGS. 18-19. The outfeed positioning system 2000 also includes a vacuum grasping system 2004 for picking refractory bricks 2012 off the conveyor 2002 to place on outfeed conveyors 2010. The vacuum grasping system 2004 may be positioned along a vertical axis by a vertical positioning system 2006 and along an X-Y direction with a carriage system 2008 that may be robotically controlled. The completed refractory bricks 2012 are placed on the outfeed conveyors 2010 for stacking in a storage configuration prepared for assembling a kiln, such as depicted in FIG. 21. The storage configuration may include stacking the refractory bricks on a pallet or organized system such that when the kiln is assembled the assembler may pick refractory bricks from the top of the storage configuration to build the base of the kiln and work from the bottom of the kiln to the top as the assembler works from the top of the storage configuration to the bottom.

FIG. 21 illustrates an example of a kiln 2100 assembled using refractory bricks produced by the system described herein, according to at least one example. The kiln 2100 includes stages 2102 that may be used to expand the capacity of the kiln 2100 by stacking additional stages 2102 to increase the capacity and size of the kiln 2100. Each stage 2102 includes refractory bricks as produced by the system described herein and may include refractory bricks having varied configurations. As an illustrative example, the stage 2102 may be formed of bricks 2104 that include grooves 2110, bricks 2106 that include grooves for crossing between grooves 2110, and bricks 2108 that include holes 2112 for probes or other such access required for control of the heating elements The various bricks need to be accessible for building the stage 2102 as-needed, and therefore the ability of the system described herein to form refractory bricks of various configurations without requiring tooling changes or setup between forming bricks of different types provides for efficient, cost-effective, and rapid production of the bricks and the kiln 2100.

The foregoing is merely illustrative of the principles of this disclosure and various modifications can be made by those skilled in the art without departing from the scope of this disclosure. The above-described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process limitations (e.g., dimensions, configurations, components, process step order, etc.) can be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

What is claimed is:

1. A production system for refractory bricks, the production system comprising:
an infeed component that receives and orients the refractory bricks in a consistent manner;
a quality control component that receives the refractory bricks from the infeed component and measures and visually inspects the refractory bricks, wherein refractory bricks failing the quality control component are rejected;
a planing component that receives accepted refractory bricks from the quality control component and planes the refractory bricks to a uniform height;
a machining component that receives planed refractory bricks and performs one or more operations according to a brick recipe defining a shape for the refractory bricks;
a bevel component that adds a bevel to edges of the refractory bricks;
a transfer system comprising one or more conveyors, robotic arms, turrets, and other such conveyor systems to transport refractory bricks between components in an automated fashion; and
a control system that receives a brick recipe describing a final shape for a brick and controls operation of the components to produce the final shape.

2. The production system of claim 1, wherein the infeed component is configured to receive one or more input streams of refractory bricks and to orient the refractory bricks on an edge on a conveyor system that extends from the infeed component to the planing component.

3. The production system of claim 1, wherein the machining component further comprises a rotary turret that receives the refractory bricks from the planing component and positions the refractory bricks between one or more stations for performing the one or more operations.

4. The production system of claim 1, wherein the control system is further configured to:
receive an assembly order for the refractory bricks;
determine a reverse assembly order describing an arrangement of refractory bricks in a storage configuration; and
transfer, using the transfer system, the refractory bricks to a storage location in the reverse assembly order.

5. The production system of claim 1, wherein the planing component, machining component, and bevel component each comprise cutters configured to grind or remove material from the refractory bricks as a powder.

6. The production system of claim 5, further comprising a dust handling system including a capture assembly configured to draw the powder from grinding operations and capture the powder for disposal.

7. The production system of claim 1, further comprising a robotic machining component comprising:
one or more rotating cutting heads; and
a robotic arm configured to retrieve refractory bricks from the transfer system and move the refractory bricks past the one or more rotating cutting heads to perform additional machining operations.

8. A method comprising:
receiving, at an infeed conveyor system, a plurality of refractory bricks;
receiving, at a controller, a kiln recipe describing dimensions and configurations of refractory bricks for assembling into a kiln;
determining, using sensor data from a sensor system, that dimensions of the plurality of refractory bricks exceed minimum dimension thresholds;
planing the plurality of refractory bricks to a predetermined height;
performing, based on the kiln recipe, one or more machining operations to create features within the plurality of refractory bricks; and
outputting the plurality of refractory bricks to a storage orientation.

9. The method of claim 8, further comprising rejecting a refractory brick based at least in part on the dimensions of the refractory brick being less than the minimum dimension thresholds.

10. The method of claim 8, wherein the one or more machining operations comprise at least one of a groove machining operation, an end beveling operation, a cold face milling operation, or a hole drilling operation.

11. The method of claim 8, wherein performing the one or more machining operations comprises rotating a turret supporting one or more refractory bricks between a plurality of stations for performing the one or more machining operations based on the kiln recipe.

12. The method of claim 8, wherein performing the one or more machining operations comprises:
releasably securing a refractory brick to a robotic arm; and
causing the robotic arm to position and move the refractory brick past a rotating cutting head to perform a machining operation.

13. The method of claim 8, further comprising cleaning the plurality of refractory bricks using an air system prior to outputting the plurality of refractory bricks.

14. The method of claim 8, wherein outputting the plurality of refractory bricks comprises printing identifiers on the plurality of refractory bricks.

15. The method of claim 8, wherein outputting the plurality of refractory bricks to the storage orientation comprises storing the refractory bricks in order for assembly of the kiln based on the kiln recipe.

16. A system, comprising:
a conveyance system;
a measurement system;
one or more rotating cutting heads;
one or more processors; and
one or more non-transitory computer-readable media having instructions stored thereon that, when executed by the one or more processors cause one or more processors to perform operations comprising:
receiving, at the conveyance system, a plurality of refractory bricks;
receiving a kiln recipe describing dimensions and configurations of refractory bricks for assembling into a kiln;
determining, using sensor data from the measurement system, that dimensions of the plurality of refractory bricks exceed minimum dimension thresholds;
planing the plurality of refractory bricks to a predetermined height using the one or more rotating cutting heads;
performing, based on the kiln recipe, one or more machining operations using the one or more rotating cutting heads to create features within the plurality of refractory bricks; and
outputting the plurality of refractory bricks to a storage orientation.

17. The system of claim 16, wherein the operations further comprise rejecting, using the conveyance system, a refractory brick based at least in part on the dimensions of the refractory brick being less than the minimum dimension thresholds.

18. The system of claim 16, wherein the conveyance system comprises:
an infeed conveyor;
a rotating turret;
an output conveyor; and
one or more transit systems to traverse between the infeed conveyor, rotating turret, and output conveyor.

19. The system of claim 16, wherein the one or more rotating cutting heads comprises:
a planing device for machining a height of the plurality of refractory bricks;
a beveling device for machining a bevel into ends of the plurality of refractory bricks;
a groove forming device to machine grooves for heating elements; and
one or more stationary cutting bits.

20. The system of claim 16, further comprising an air system configured to clean dust off the plurality of refractory bricks prior to outputting the plurality of refractory bricks.
